(19) United States
(12) Patent Application Publication
(10) Pub. No.: US 2017/0147961 A1
(43) Pub. Date: May 25, 2017

(54) ADJUSTMENT OF CHANGE REQUESTS

(71) Applicant: International Business Machines Corporation, Armonk, NY (US)

(72) Inventors: Richard M. Haas, Wellesley, MA (US); Randy S. Johnson, O'Fallon, MO (US); Tedrick N. Northway, Wood River, IL (US); H. William Rinckel, Prospect, CT (US)

(21) Appl. No.: 14/945,751

(22) Filed: Nov. 19, 2015

(51) Int. Cl. G06Q 10/06

(52) U.S. Cl. CPC G06Q 10/063118; G06Q 10/063112

(57) ABSTRACT

A method, computer program product and a computer system is provided. A processor receives a change request. A processor identifies a category of the change request. A processor identifies at least one available resource with a characteristic that matches a criterion as dictated by the change request. A processor determines a technical lead-time for a first available resource of the at least one available resources. A processor determines an administrative lead-time based, at least in part, on the category of the change request. A processor generates a total lead-time for the first available resource based, at least in part, on the technical lead-time and the administrative lead-time. A processor sends a solution to a requestor of the change request, based, at least in part, on the total lead-time for the first available resource and the category of the change request.

### BACKGROUND OF THE INVENTION

The present invention relates generally to the field of change requests, and more particularly to adjusting fulfillment of change requests.

A change request is a request to change a product or service provided to a client. The client requests changes to be made to the product or service including, changes to existing features, adding new features, or removing existing features. A good example of the change requests can be found in software development. Often users report bugs or desire new functionality from their software programs, which leads to a change request. The software provider then looks into the technical and economical feasibility of implementing this change, such as allocating resources to perform the change request

### SUMMARY

Embodiments of the present invention provide a method, system, and program product to adjust lead-times. A processor receives a change request. A processor receives a change request. A processor identifies a category of the change request. A processor identifies at least one available resource with a characteristic that matches a criterion as dictated by the change request. A processor determines a technical lead-time for a first available resource of the at least one available resources. A processor determines an administrative lead-time based, at least in part, on the category of the change request. A processor generates a total lead-time for the first available resource based, at least in part, on the technical lead-time and the administrative lead-time. A processor sends a solution to a requestor of the change request, based, at least in part, on the total lead-time for the first available resource and the category of the change request.

### BRIEF DESCRIPTION OF THE SEVERAL VIEWS OF THE DRAWINGS

FIG. 1 is a functional block diagram illustrating a networked environment, in accordance with an embodiment of the present invention.

FIG. 2 illustrates operational processes of an adjustment program adjusting lead-times, on a computing device within the environment of FIG. 1, in accordance with an embodiment of the present invention.

FIG. 3 illustrates operational processes of an adjustment program determining lead-times based on a change request, on a computing device within the environment of FIG. 1, in accordance with an embodiment of the present invention.

FIG. 4 depicts a block diagram of components of the computing device executing an adjustment program, in accordance with an embodiment of the present invention.

### DETAILED DESCRIPTION

While solutions to handling change requests are known, they typically assign the first available resource to perform the change request. As such, the assignment of the resource may not be optimal. Most prior solutions are static in nature set either by rigid policies or rules. Embodiments of the present invention recognize that by taking into account previous performances of the resource into account provide a better optimization of assignment. By incorporating successes and failures in previous assignments, embodiments of the present invention provide assignment of resources with more efficient lead-times to perform the change request. Furthermore, some embodiments of the present invention give more weight to recent successes and failures to better represent the resources current performance.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

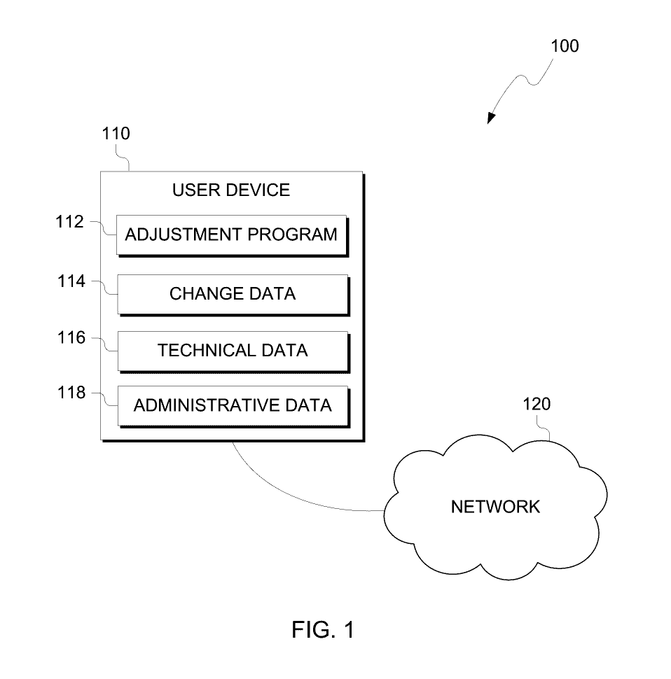

The present invention will now be described in detail with reference to the Figures. FIG. 1 is a functional block diagram illustrating networked environment, generally designated 100, in accordance with one embodiment of the present invention. Networked environment 100 includes user device 110 connected to network 120. User device 110 includes adjusting program 112, change data 114, technical data 116, and administrative data 118.

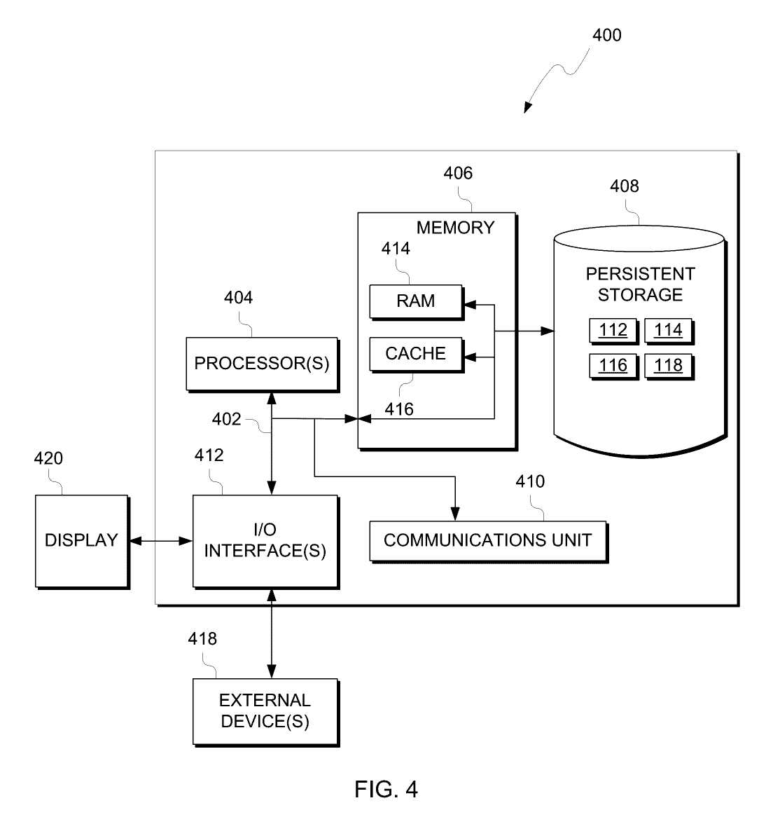

In various embodiments of the present invention, user device 110 is a computing device that can be a standalone device, a server, a laptop computer, a tablet computer, a netbook computer, a personal computer (PC), or a desktop computer. In another embodiment, user device 110 represents a computing system utilizing clustered computers and components to act as a single pool of seamless resources. In general, user device 110 can be any computing device or a combination of devices with access to change data 114, technical data 116, administrative data 118 and is capable of executing adjustment program 112. User device 110 may include internal and external hardware components, as depicted and described in further detail with respect to FIG. 4.

In this exemplary embodiment, adjustment program 112, change data 114, technical data 116, and administrative data 118 are stored on user device 110. However, in other embodiments, adjustment program 112, change data 114, technical data 116, and administrative data 118 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between user device 110 and other devices (not shown), in accordance with a desired embodiment of the present invention.

In various embodiments, adjustment program 112 receives a change request. A change request is supplied by a user or client of a product or service. In some embodiments and scenarios, the change request includes a request for new functionality to the product or service, problems encountered by the user or client when using the product or service, changes to existing functions of the product or service, or any request that leads to changes or alterations to the product or service. Based on the received change request, adjusting program 112 determines one or more analysis categories for the request. In some scenarios, adjusting program 112 determines analysis categories based on the type of the request. For example, two categories represent “feature requests” and “problem reports”. In another scenario, analysis categories also include a risk or complexity level of the change request. For example, in one embodiments and scenario, the risk level of the request is based on the portion of the product or service the change request is directed towards (e.g., a lower risk is assigned to a user interface request and a higher risk to a backend application request). In another embodiment and scenario, the analysis categories are cross-referenced or combined to represent particular instances of change request (e.g., a “low risk feature request” or a “high complexity problem report”). In some embodiments, adjustment program 112 categorizes a change request by one or more analysis categories including, but are not limited to, user or client, change request type, risk level, complexity level, scope (e.g., the portion or parts of the product or service effected by the request), environment (e.g., the tools used to affect the change, such as hardware or software environment used to make the change), and the like. In various embodiments, adjustment program 112 stores the change request and the determined analysis categories in change data 114.

In various embodiments, adjustment program 112 identifies available resources to handle the change request. In some scenarios, a resource is known to provide a solution for that particular type of change request or a similar type of change request. As non-limiting examples, as used herein, a resource can be a particular hardware, software, service, company, or procedure. In general, a resource can be any type of solution that will facilitate, or otherwise provide at least a portion of a solution/response to a particular type of change request. For example, “company A” is known to provide solutions for database maintenance. The change request specifies that a consumer of a product has indicated that the software for database maintenance is not meeting the needs of the consumer. As such, adjustment program 112 identifies available resources to handle that type of change request, which include “company A”. In various embodiments adjustment program 112 determines an available resource or resources to assign the change request. Based on the categorization of the change request, adjustment program 112 identifies resources capable of performing the change request. For example, if a particular knowledge of an environment is needed to complete the change request, then adjustment program 112 identifies resources with knowledge of the environment pertaining to the change request. In some scenarios, the change request includes an expected time for the change (e.g., a deadline). As discussed herein, adjustment program 112 determines if a resource is available if the resource lead-time for the resource is within the expected time for the change request. In some scenarios, adjustment program 112 retrieves a schedule for the resource. Based on the schedule, adjustment program 112 determines if the resource is available for assignment to the change request.

In various embodiments, adjustment program 112 determines lead-times for available resources for a change request. Adjustment program 112 determines a lead-time for a change request by the following:

T=T_{T}+T_{A} (E.1)

In E.1 above, adjustment program 112 combines a technical time, T_{T}, and an administrative time, T_{A}, to determine a total lead-time, T, for a particular change request. The technical time for a change request represents the expected lead-time a resource will take to perform the change request. As used herein, the administrative time represents the expected amount of time non-technical tasks will take to complete in order to provide a solution to the change request. For example, a change request asks for a new feature to be added to an existing software product. Various resources may perform the technical aspect of request (e.g., prototyping and coding the new feature). For each resource, a technical time is determined. Administrative time includes tasks performed to ensure the technical portion of fulfilling the request meets an organization's policies or standards (e.g., testing, quality assurance, intake of change request, shipping of a solution for the change request, etc.).

Adjustment program 112 determines a technical time for each resource based on the following:

$${T}_{T} = {D}_{T} [ 1 + {W}_{ST} \cdot \frac{{T}_{S} - {D}_{T}}{{D}_{T}} + {W}_{FT} \cdot \frac{\vert {T}_{F} - {D}_{T} \vert}{{D}_{T}} ] \qquad ( E . 2 )$$

In E.2, D_{T} represents a default technical time for a resource to perform the change request. Based on the categorization of request, each resource is assigned a default technical time to perform the change request. In some scenarios, adjustment program 112 receives a default technical time for each resource. In other scenarios, adjustment program 112 determines a default technical time based on the role, skill, other factor indicating experience or proficiency of each resource. For example, adjustment program 112 assigns a lower default technical time to a more experienced resource with a proven history of addressing a particular type of change request than a more recently created resource, since the more experienced resource is expected to be more proficient and complete the change request quicker than a lesser experienced resource.

In E.2, W_{ST} and W_{FT} represent weighting factors to adjust the importance of previous technical successes and technical failures, respectively. For example, adjustment program 112 places a higher weight to failures (e.g., W_{FT}=80%) to emphasize the impact a failure has on an organization (e.g., reworks and additional time to handle the failure). As another example, adjustment program 112 places a higher weight to successes (e.g., W_{ST}=60%) to locate potential mentors for training that have a high rate of success.

In E.2, T_{S} represents the average time the resource spent on prior successes for change requests under a similar categorization (e.g., change request type, complexity, or scope). Adjustment program 112 determines an average success time, T_{S}, based on the following:

T_{S}=Σᵢ₌₁^{N}aᵢsᵢ (E.3)

In E.3, N represents the total number of successful changes with the same categorization as the received change request performed by the resource. For example, a resource has performed five bug reports in the past, and three of those where successes (e.g., the resource performed the necessary tasks to fix the bug). sᵢ represents the amount of technical time it took the resource to finish each change request that was a success. For example, a resource had three past successes, each with a respective technical time of 16 minutes, 12 minutes, and 14 minutes. aᵢ represents a weighting factor to differentiate between the time the successes occurred, where Σᵢ₌₁^{N} aᵢ=1. For example, larger weights are given to more recent successes to provide a better reflection of current performance. As another example, a uniform weight is given to indicate resources with a more consistent performance.

Referring back to E.2, T_{F} represents the average time the resource spent on prior failures for change requests under a similar categorization (e.g., change request type, complexity, or scope). Adjustment program 112 determines an average failure time, T_{F}, based on the following:

T_{F}=Σᵢ₌₁^{M}bᵢfᵢ (E.4)

In E.4, M represents the total number of failed change requests with the same categorization as the received change request performed by the resource. For example, a resource has performed five bug reports in the past, and two of those where failures (e.g., the resource failed to fix the bug). fᵢ represents the amount of technical time it took the resource to finish each change request that was a failure. For example, a resource had two past failures, each with a respective technical time of 22 minutes and 34 minutes. bᵢ represents a weighting factor to differentiate between the time the failures occurred, where Σᵢ₌₁^{M} bᵢ=1. For example, larger weights are given to more recent failures to provide a better reflection of current performance. As another example, a uniform weight is given to indicate resources with a more consistent performance.

Referring back E.2, adjustment program 112 determines a technical time for a resource based on a default technical time, where the default time is based on categorization of the change request and skills and experience of the resource. Additionally, technical time for a change request is further based on the average success and failure times for the resource handling similar change requests. In some embodiments, a weight is applied to the average success and failure times to provide a different focus on successes or failures. Adjusting program 112 determines a success adjustment amount by subtracting the default technical time from the average success time. Adjusting program 112 determines a failure adjustment amount by subtracting the default technical time from the average failure time. Both the success adjustment amount and the failure adjustment amount are combined, as illustrated in E.2, to adjust the default technical time. As such, the adjusted technical time is the technical time, T_{T}, of the resource.

In various embodiments, technical data 116 includes previous categorized change requests for each resource. For example, technical data 116 is categorized to include two types of change requests, new feature requests and bug reports. Of the two categories, each are further organized based on complexity (e.g., high complexity feature requests, low complexity feature requests, high complexity bug reports, and low complexity bug reports). For each change request category and analysis category, technical data 116 the time a resource took to perform a request and whether the work performed was a success or a failure. Furthermore, technical data 116 includes the technical default time for each category of change request based on the proficiency of the resource (e.g., based on skills, role, or experience).

Referring back to E.1, adjustment program 112 determines an administrative time, T_{A}, for the change request by the following:

T_{A}=T_{A}^{min}+β_{A} (E.5)

In E.5, adjustment program 112 determines administrative time for a change request based on two components, a minimum administrative time, T_{A}^{min} and an adjustment factor, δ_{A}. The minimum administrative time represents the base amount of time an organization takes for any type of change request. Adjusting program 112 determines a minimum administrative time based on previous administrative performances. In some scenario, adjustment program 112 selects the lowest time from prior administrative data 118. In other scenarios, adjustment program 112 receives a user-defined value for minimum administrative time.

For a change request, adjustment program 112 determines an adjustment factor for the category of the change request and, in some embodiments, any analysis categories associated with the change request (e.g., complexity, environment, etc.). The adjustment factor adjust the minimum administrative time based on prior administrative handlings of similar change requests. Adjustment program 112 determines the adjustment factor based on the following:

$${δ}_{A} = ( {D}_{A} - {T}_{A}^{m i n} ) [ 1 + \frac{{W}_{FA} \cdot {\sum }_{i = 1}^{M} {d}_{i} {f}_{i} - {W}_{SA} \cdot {\sum }_{i = 1}^{N} {c}_{i} {s}_{i}}{{\sum }_{i = 1}^{M} {d}_{i} {f}_{i} + {\sum }_{i = 1}^{N} {c}_{i} {s}_{i}} ] \qquad ( E . 6 )$$

In E.6, adjustment program 112 determines an adjustment factor, δ_{A}. D_{A} represents a default administrative time for the particular type of change request. For example, a new feature request requires more time for testing and approval than for a bug fix. W_{FA} and W_{SA} each represent a weighting factor for previous administrative failures and administrative successes, respectively. dᵢ and cᵢ are weighting factors to account for the timing of administrative failures and successes. For example, adjustment program 112 uses a larger weight for more recent failures to reflect recent performance. fᵢ and sᵢ are prior amounts of administrative time spent for similar types of changes requests.

Referring back to E.5, adjustment program 112 determines an adjustment factor for administrative work for a particular type of change request. Based on past successes and failures, and the time spent on each, the adjustment factor provides an adjustment to the minimum administrative time to determine an administrative time for the change request. Referring back to E.1, the administrative time and the technical time for each resource are combined to determine the total lead-time for a change request. As discussed herein, based on the total lead-time for each resource, adjustment program 112 determines an assignment to an incoming change request of a resource.

In various embodiments, administrative data 118 includes a minimum administrative time for all change requests. Furthermore, based on the categorization of change requests, administrative data 118 includes previous administrative times spent on types of change requests and whether the work performed by a resource resulted in a success or failure. As such, successes and failures for administrative tasks are indicated by the performance of the resource. For example, a resource performed the tasks requested in a change request, however the result did not satisfy the function included in the change request. In some embodiments, administrative data 118 also includes the resource that the administrative tasks are being performed in response to technical tasks the resource performed. In such embodiments, administrative time only includes administrative data 118 with previous administrative work attributed to the resource.

In some embodiments, adjustment program 112 determines assignments to change requests based on the total lead-time, T, referred to in E.1. In some scenarios, adjustment program 112 assigns the available resource with the smallest total lead-time. In other scenarios, adjustment program 112 assigns resources based on an optimal assignment of various available resources and various change requests. For example, adjustment program 112 determines an assignment efficiency value that represents the percentage of time resources are assigned over a period of time. For example, over the next month, adjustment program 112 maximizes the amount of resources assigned during the period. One of ordinary skill in the art will appreciate that any method of assignment of resources based on the determined total lead-time of change requests can be used without deviating from the invention.

In some embodiments, adjustment program 112 determines a training or mentorship of resources. Based on the total lead-time for certain change request types, adjustment program 112 determines skilled resources to mentor others regarding the change request types. Adjustment program 112 generates training programs to aid other resources with high lead-times for similar requests. For example, one resource has a low lead-time for bug reports in a certain software product. Adjustment program 112 identifies other resources with higher lead-times and generates a training program 112 where the resource with the low lead-time leads the training program.

In some embodiments, adjustment program 112 determines rewards or promotions for resources based on total lead-times. For example, adjustment program 112 uses weighting factors that favor more recent change requests (e.g., in E.3, aᵢ<aᵢ₊₁). Adjustment program 112 selects one or more resources with lower total lead-times or technical times for promotion or rewards. As such, resources with better recent performance can be acknowledged or awarded. In another example, adjustment program 112 determines if a resource's performance is improving or worsening over time. For example, adjustment program 112 determines two total lead-times (i.e., E.1) or technical times (i.e., E.2) for each resource. In one determination, adjustment program 112 applies larger weights to past performance (e.g., in E.3, aᵢ>aᵢ₊₁). In the second determination, adjustment program 112 applies larger weights to current performance (e.g., in E.3, aᵢ<aᵢ₊₁). Based on the lead-times or technical times, adjustment program 112 determines if the resource has improved over time. For example, if the currently weighted time is smaller than the past weighted time, then adjustment program 112 determines the resource has improved recently. Conversely if the past weighted time is smaller than the currently weighted time, then the resources performance has worsened over time. As such, adjustment program 112 can generates rewards, promotions, demerits or retraining based on such a determination.

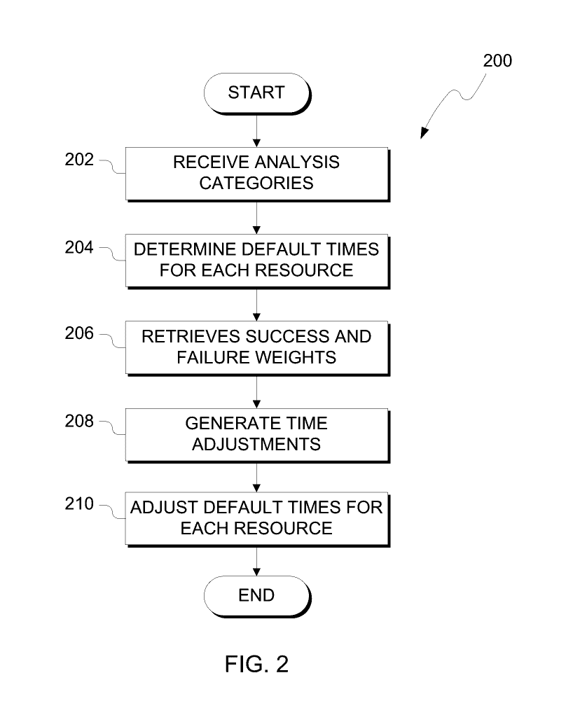

FIG. 2 illustrates operational processes, generally designated 200, of adjustment program 112 adjusting lead-times of various resources. In some embodiments, adjustment program 112 determine total lead-times for various resources. As resources perform change requests, performance data associated with each change request are stored in technical data 116 and administrative data 118. For example, when a resource performs a change request the amount of time spent on technical tasks by the resource is stored in technical data 116 and the amount of time spent on administrative tasks related to the change request are stored in administrative data 118. Additionally, both technical data 116 and administrative data 118 include whether the change request was a success or failure. FIG. 2 illustrates adjustment program 112 determining adjusted lead-times in batches, where technical data 116 and administrative data 118 include performance reports for various change requests that have yet to be accounted (e.g., the default lead-times are not yet adjusted). In some embodiments, adjustment program 112 determines total lead-time adjustments as performance reports are stored in technical data 116 or administrative data 118.

In process 202, adjustment program 112 receives one or more analysis categories. Adjustment program 112 receives one or more analysis categories to monitor in technical data 116 and administrative data 118. For example, adjustment program 112 receives from a user the types of complexity, risk, scope, or environment to categorize incoming change requests. In some embodiments, adjustment program 112 receives one or more types of change requests to categorize incoming change request. As an example, software change request types include new features, bug reports, and additional platform support. Based on the categorization, adjustment program 112 determines default lead-times for technical time (i.e., D_{T}), and administrative time (i.e., D_{A}).

In process 204, adjustment program 112 determines default lead-times for each resource, based on the type of change request in change data 114 and any analysis categories indicated therein. In some scenarios, adjustment program 112 analyzes prior technical data 116 and administrative data 118 to determine a default time for each. In one scenario, adjustment program 112 selects the smallest time from technical data 116 and administrative data that meets the categorization. For example, when determining the default time for a high-risk bug report, adjustment program 112 retrieves all technical data 116 and administrative data 118 that has a similar criteria (e.g., other high-risk bug fixes). The fastest time for both technical tasks and administrative tasks are used for the respective default technical time and default administrative time. In another scenario, adjustment program 112 performs statistical analysis of both technical data 116 and administrative data 118 to determine default technical time and default administrative time. For example, adjustment program 112 selects the top tenth percentile time from all technical data 116 and administrative data 118 that has a similar criteria to the current change request that a default time is being determined for.

In process 206, adjustment program 112 retrieves the weights for successes and failures for technical time determinations (e.g. W_{ST}, W_{FT}, aᵢ, and bᵢ), and administrative time determinations (e.g. W_{SA}, W_{FA}, cᵢ, and dᵢ). In some embodiments, adjustment program 112 receives the weights from a user. In other embodiments, adjustment program 112 determines the weights based on a desired result from a user. For example, if adjustment program 112 is instructed to determine an assignment of resources, adjustment program 112 determines the weights should favor more recent occurrences (e.g., aᵢ<aᵢ₊₁) and failures are given more weight to ensure the change requests are successful (e.g., W_{ST}<W_{FT}). As another example, if adjustment program 112 is instructed to determine mentorship or training recommendations, adjustment program 112 selects a uniform weight to favor consistent performance by resources.

In process 208, adjustment program 112 generates the time adjustments for technical time and administrative time for each resource and each change request categorization. Based on the default time and the offset of the weighted averages of success and failure times, adjustment program 112 determines an adjustment time for both technical and administrative time components of the total lead-time for a resource and categorization. Adjustment program 112 retrieves technical data 116 and administrative data 118 for the resource that meets the categorization (e.g., previous new feature requests in a particular software environment that where performed by the resource). In process 210, adjustment program 112 combines the default times for both technical and administrative tasks, as determined in process 204, with the respective adjustment factors, as determined in process 208. The adjusted default time provide an indication of the performance of the resource for the given categorization of a change request.

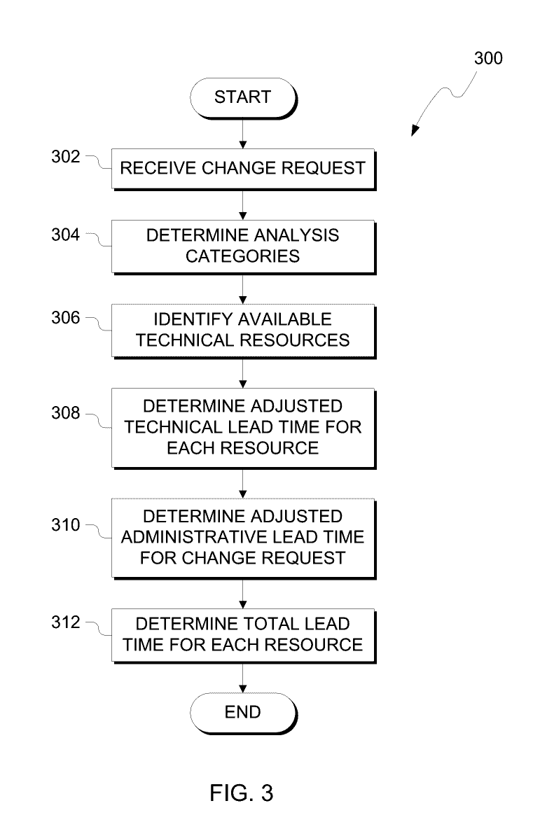

FIG. 3 illustrates operational processes, generally designated 300, of adjustment program 112 determining lead-times based on a change request. In process 302, adjustment program 112 receives a change request. In various scenarios, the change request includes a description of the change a client or user requests to have made in a product or service. In process, 304, adjustment program 112 determines analysis categories for the incoming change request. Based on the description of the change request, adjustment program 112 determines the analysis categories. For example, change request includes an indication of a change type (e.g., a “new feature” is selected in an electronic form). As another example, if the change request is for a certain product or in a particular environment, then adjustment program 112 selects a pre-determined categorization (e.g., one request is for Product A and adjustment program determines the categorization to be “low risk”). In some scenarios, adjustment program 112 performs natural language processing (NLP) to the contents of a change request to determine the analysis categorization of the change request. For example, a change request includes a describing a bug report such as “When I select this interface element of Software Product A, the application crashes.” By using NLP, adjustment program 112 determines the environment “UI in Software Product A” and a “high complexity” based on the crash report as analysis categories. In various embodiments, adjustment program 112 stores the categorized change request in change data 114.

In process 306, adjustment program 112 identifies available resources capable of performing, i.e. are capable of providing a solution to, the incoming change request. In some scenarios, adjustment program 112 retrieves a list of available resources. In further scenarios, adjustment program 112 identifies a completion date for the change request. In one example, the client includes a completion date with the change request. In another example, adjustment program 112 determines a completion date based on the categorization of the change request. For example, adjustment program 112 determines a completion date based on the type of change request (e.g., a new feature may have a longer time for completion than a bug fix). Based on the completion date and total lead-times, determined and discussed in process 312, adjustment program 112 does not consider resources who cannot complete the change request by the completion date as indicated in the total lead-time for the resource.

In process 308, adjustment program 112 determines an adjusted technical time for each resource. As discussed herein, adjustment program 112 retrieves a default technical time based on the categorization of the change request. For example, a medium-complexity feature request from Client A in software Product B has a default technical time of twelve days. In some embodiments, adjustment program 112 receives the default technical time from a user. In other embodiments, adjustment program 112 determines a default technical time based on statistical analysis of technical data 116. For example, adjustment program 112 identifies technical data 116 with a similar categorization as the change request and, based on the previous similarly categorized requests and the respective times spent on the request, determines a default technical time. In various embodiments, adjustment program 112 determines an individual technical adjustment factor for each available resource. Adjustment program 112 determines a technical adjustment factor for a resource based on a weighted time average of both previous times spent on successes and failures made by the resource, where the previous successes and failures were for change requests with similar categorization as the incoming change request. Adjustment program 112 adjusts the default technical time by the technical adjustment factor for each resource to determine an adjusted technical time for each resource.

In process 310, adjustment program 112 determines an adjusted administrative time based on the categorization of the change request. Adjustment program 112 adjusts a minimum administrative time and default administrative time for the change request type to determines the adjusted administrative time of the incoming change request. In some embodiments, adjustment program 112 receives a minimum administrative time or a default administrative time from a user. In other embodiments, adjustment program 112 determines a minimum administrative time or a default administrative time based on previous administrative data 118. Minimum administrative time represent a base or minimum amount of time spent on administrative tasks for all types of change request. Default administrative time is the base amount of time spent on change requests with similar categorization as the incoming change requests (e.g., previous bug reports in software product A, given that the incoming request is for a bug report in software product A). In various embodiments, adjustment program 112 adjusts a minimum administrative time and default administrative time based on an administrative adjustment factor. Based on a weighted average of previous administrative times spent on success and failures with a similar categorization as the incoming change request, adjustment program 112 determines an administrative adjustment factor. Adjustment program 112 adjusts the minimum administrative time and default administrative time with the administrative adjustment factor to determine an adjusted administrative time for the change request.

In some embodiments, when adjustment program 112 determines an administrative adjustment factor, adjustment program 112 retrieves administrative data 118 associated with the resource. Adjustment program 112 retrieves administrative success and failure times for administrative tasks related to technical work done by the resource. As such, adjustment program 112 determines not only the resource impact on technical time, as determined in process 308, but also the resources impact on administrative time.

In process 312, adjustment program 112 combines the adjusted technical time and the adjusted administrative time to determine the total lead-time each resource is expected to complete the change request. In some scenarios, adjustment program 112 determines an assignment to the change request based on the total time for each resource. For example, adjustment program 112 selects the resource with the smallest total time. In other scenarios, adjustment program 112 determines a training or mentorship program between resources. For example, resources with low total times are indicated as trainers or mentors for resources with larger total times. In another scenario, adjustment program 112 determines rewards, promotions, demerits, and the like to one or more resources based on total time. As an example, for resources with lower total times, adjustment program 112 indicates the approval of a reward or promotion to the resource.

In various embodiments, adjustment program 112 sends a solution for the change request to the requestor. In some scenarios, adjustment program 112 assigns the change request to the resource to perform the requested change. After the resource performs the tasks to complete the change request, adjustment program 112 sends a finished solution (e.g., a new build of software or a repaired product) to the change request. In other scenarios, adjustment program 112 includes one or more pre-determined series of tasks to provide solutions to different types of change requests. For example, for a bug report, adjustment program 112 includes the tasks required to perform a change request regarding the bug report (e.g., replicate bug, determine suspect software components, and repeat input that previously caused the bug). In some embodiments, the tasks of a given solution also vary based on the analysis categories for the change request (e.g., different tasks for different clients). In further embodiments, adjustment program 112 selects a set of tasks for a solution based on the total lead-time and the analysis categories of the request. For example, if a resource has a lower than expected total lead-time, then adjustment program 112 selects a more detailed or thorough set of tasks. As another example, if the total lead-time is below a certain threshold from the completion date, then adjustment program 112 selects a more detailed or thorough set of tasks. Conversely, if no available resource is below the threshold, the adjustment program 112 provides, for example, a set of tasks for the solution with fewer or less complicated steps.

In some embodiments, adjustment program 112 determines resource availability or other constraints that affect the ability of the resource to perform a change request. If a resource or resources do not meet one or more constraints, then adjustment program 112 does not assign the resource to the change request. In one scenario, adjustment program 112 determines if enough component parts are on hand or will be available in time to perform the change request within the requested completion date indicated in the change request. For example, to perform a change request to replace a broken part, adjustment program 112 identifies that a predetermined number of components are necessary (e.g., a new assembly, thirty fasteners, etc.). Adjustment program 112 retrieves an inventory of parts on hand to determine if enough components are in possession to complete the change request. If not enough components are on hand, adjustment program 112 evaluates another resource (e.g., another repair facility). In some scenarios, if not enough components are on hand, then adjustment program 112 determines if enough components can be produced or shipped to the resource before the completion date. If enough component parts can be made available to the resource before the completion date, in addition to the parts on hand, to complete the change request, then adjustment program 112 includes the resource during assignment.

FIG. 4 depicts a block diagram, 400, of components of user device 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

User device 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Adjustment program 112, change data 114, technical data 116, and administrative data 118 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 120. In these examples, communications unit 410 includes one or more network interface cards. Communications unit 410 may provide communications through the use of either or both physical and wireless communications links. Adjustment program 112, change data 114, technical data 116, and administrative data 118 may be downloaded to persistent storage 408 through communications unit 410.

I/O interface(s) 412 allows for input and output of data with other devices that may be connected to user device 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., adjustment program 112, change data 114, technical data 116, and administrative data 118, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method of comprising:
receiving, by one or more processors, a change request;
identifying, by the one or more processors, a category of the change request;
identifying, by the one or more processors, at least one available resource with a characteristic that matches a criterion as dictated by the change request;
determining, by the one or more processors, a technical lead-time for a first available resource of the at least one available resources, (a) wherein the technical lead-time for the first available resource is based, at least in part, on both of (i) one or more previous technical successes of the first available resource; and (ii) one or more previous technical failures of the first available resource; and (b) wherein more recent values of the one or more previous technical successes and the one or more previous technical failures of the first available resource are assigned a greater weight than less recent values of the one or more previous technical successes and the one or more previous technical failures of the first available resource;
determining, by the one or more processors, an administrative lead-time based, at least in part, on the category of the change request;
generating, by the one or more processors, a total lead-time for the first available resource based, at least in part, on the technical lead-time and the administrative lead-time; and
in response to a determination that the total lead time of the first available resource is less than a total lead time of a second available resource, assigning, by the one or more processors, the first available resource to the change request.

2-3. (canceled)

4. The method of claim 1, wherein the technical lead-time for the first available resource is based, at least in part, on one or more of the following: (i) a role of the first available resource; (ii) experience of the first available resource; (iii) complexity of the change request; (iv) risk level of the change request; and (v) an environment related to the change request.

5. The method of claim 1, wherein the administrative lead-time is based, at least in part, on a minimum administrative time and an administrative adjustment time.

6. The method of claim 5, the method further comprising:
determining, by the one or more processors, the administrative adjustment time based, at least in part, on both of (i) one or more previous administrative successes in the category of the change request; and (ii) one or more previous administrative failures in the category of the change request.

7. The method of claim 1, the method further comprising:
determining, by the one or more processors, a technical lead-time for a third available resource of the at least one available resources; and
responsive to the technical lead-time for the third available resource being greater than the technical lead-time of the first available resource, generating, by the one or more processors, a training request for the third available resource, wherein the first available resource is the mentor in the training request.

8. A computer program product comprising:
one or more computer-readable storage media and program instructions stored on the one or more computer-readable storage media, the program instructions comprising:
program instructions to receive a change request;
program instructions to identify a category of the change request;
program instructions to identify at least one available resource with a characteristic that matches a criterion as dictated by the change request;
program instructions to determine a technical lead-time for a first available resource of the at least one available resources, wherein the technical lead-time for the first available resource is based, at least in part, on both of (i) one or more previous technical successes of the first available resource; and (ii) one or more previous technical failures of the first available resource, wherein more recent values of the one or more previous technical successes and the one or more previous technical failures of the first available resource are assigned a greater weight than less recent values of the one or more previous technical successes and the one or more previous technical failures of the first available resource;
program instructions to determine an administrative lead-time based, at least in part, on the category of the change request;
program instructions to generate a total lead-time for the first available resource based, at least in part, on the technical lead-time and the administrative lead-time; and
in response to a determination that the total lead time of the first available resource is less than a total lead time of a second available resource, program instructions to assign the first available resource to the change request.

9-10. (canceled)

11. The computer program product of claim 8, wherein the technical lead-time for the first available resource is based, at least in part, on one or more of the following: (i) a role of the first available resource; (ii) experience of the first available resource; (iii) complexity of the change request; (iv) risk level of the change request; and (v) an environment related to the change request.

12. The computer program product of claim 8, wherein the administrative lead-time is based, at least in part, on a minimum administrative time and an administrative adjustment time.

13. The computer program product of claim 12, the program instructions further comprising:
program instructions to determine the administrative adjustment time based, at least in part, on both of (i) one or more previous administrative successes in the category of the change request; and (ii) one or more previous administrative failures in the category of the change request.

14. The computer program product of claim 8, the program instructions further comprising:
program instructions to determine a technical lead-time for a third available resource of the at least one available resources; and
responsive to the technical lead-time for the third available resource being greater than the technical lead-time of the first available resource, program instructions to generate a training request for the third available resource, wherein the first available resource is the mentor in the training request.

15. A computer system for comprising:
one or more computer processors;
one or more computer readable storage media; and
program instructions stored on the computer readable storage media for execution by at least one of the one or more processors, the program instructions comprising:
program instructions to receive a change request;
program instructions to identify a category of the change request;
program instructions to identify at least one available resource with a characteristic that matches a criterion as dictated by the change request;
program instructions to determine a technical lead-time for a first available resource of the at least one available resources, wherein the technical lead-time for the first available resource is based, at least in part, on both of (i) one or more previous technical successes of the first available resource; and (ii) one or more previous technical failures of the first available resource, wherein more recent values of the one or more previous technical successes and the one or more previous technical failures of the first available resource are assigned a greater weight than less recent values of the one or more previous technical successes and the one or more previous technical failures of the first available resource;
program instructions to determine an administrative lead-time based, at least in part, on the category of the change request;
program instructions to generate a total lead-time for the first available resource based, at least in part, on the technical lead-time and the administrative lead-time; and
in response to a determination that the total lead time of the first available resource is less than a total lead time of a second available resource, program instructions to assign the first available resource to the change request.

16-17. (canceled)

18. The computer system of claim 15, wherein the technical lead-time for the first available resource is based, at least in part, on one or more of the following: (i) a role of the first available resource; (ii) experience of the first available resource; (iii) complexity of the change request; (iv) risk level of the change request; and (v) an environment related to the change request.

19. The computer system of claim 15, wherein the administrative lead-time is based, at least in part, on a minimum administrative time and an administrative adjustment time.

20. The computer system of claim 19, the program instructions further comprising:
program instructions to determine the administrative adjustment time based, at least in part, on both of (i) one or more previous administrative successes in the category of the change request; and (ii) one or more previous administrative failures in the category of the change request.
